(19) United States
(12) Patent Application Publication
(10) Pub. No.: US 2025/0355644 A1
(43) Pub. Date: Nov. 20, 2025

(54) AUTOMATIC SOFTWARE GENERATION

(71) Applicant: Chevron U.S.A. Inc., San Ramon, CA (US)

(72) Inventors: Larry A. Bowden, JR., Houston, TX (US); Nathan Dennis Church, Houston, TX (US); Ian S. Smith, Houston, TX (US)

(21) Appl. No.: 18/663,959

(22) Filed: May 14, 2024

(51) Int. Cl. G06F 8/36; G06F 8/10

(52) U.S. Cl. CPC G06F 8/36; G06F 8/10

(57) ABSTRACT

An automatic software generation tool with improved search and retrieval capabilities for existing code generates, stores, and utilizes separate embeddings for code chunks and code chunk labels. Requirements for a new software application are used to generate a pseudocode for the new software application, and code chunks to be used in the new software application are identified using the pseudocode and the embeddings. The new software application is automatically generated using the identified code chunks.

### FIELD

The present disclosure relates generally to the field of automatic software generation using code chunk embeddings and code chunk label embeddings.

### BACKGROUND

Software development is a complex and time-consuming process. Software developers may search for existing code for reuse or modification. Traditional methods of searching for relevant code may be inefficient and error-prone, resulting in wasted time and resources.

### SUMMARY

This disclosure relates to automatic software generation. A set of code may be obtained. Code chunks within the set of code may be classified. Individual code chunks may be associated with code chunk labels. Code chunk embeddings for the code chunks and code chunk label embeddings for the code chunk labels may be generated. The code chunk embeddings may facilitate classification of the code chunks within the set of code. The code chunk label embeddings may facilitate identification of the code chunks from the set of code. The code chunk embeddings and the code chunk label embeddings may be stored in an embeddings database.

One or more requirements of a new software application to be generated may be obtained. A pseudocode for the new software application to be generated may be generated based on the requirement(s) of the new software application and/or other information. One or more of the code chunks may be identified for use in generating the new software application based on the pseudocode for the new software application, the code chunk label embeddings, and/or other information. The new software application may be generated based on the identified code chunk(s) and/or other information.

A system for automatic software generation may include one or more electronic storage, one or more processors, and/or other components. The electronic storage may store information relating to code, information relating to code chunks, information relating to code chunk labels, information relating to embeddings, information relating to code chunk embeddings, information relating to code chunk label embeddings, information relating to pseudocode, information relating to software applications, information relating to identification of code chunks, information relating to generation of software applications, and/or other information.

The processor(s) may be configured by machine-readable instructions. Executing the machine-readable instructions may cause the processor(s) to facilitate automatic software generation. The machine-readable instructions may include one or more computer program components. The computer program components may include one or more of a code component, a code chunk component, an embedding component, a storage component, a requirement component, a pseudocode component, an identification component, a generation component, and/or other computer program components.

The code component may be configured to obtain a set of code. The set of code may include existing code.

The code chunk component may be configured to classify code chunks within the set of code. Individual code chunks may be associated with code chunk labels. In some implementations, a given code chunk label for a given code chunk may be generated by a large language model based on the given code chunk and/or other information. In some implementations, the classification of the code chunks may be performed based on one or more code writing standards and/or other information.

In some implementations, the classification of a given code chunk may include identification and/or labeling of the given code chunk. In some implementations, the classification of the code chunks within the set of code may be performed based on a code chunk hierarchy template and/or other information. In some implementations, the code chunk hierarchy template may include a name field, a description field, a function field, a technology field, an interface field, a database field, a file type field, a parameters field, a return type field, an implements field, a depends on field, an interacts with field, a mode field, a code field, and/or other fields.

The embedding component may be configured to generate embeddings. The embedding component may be configured to generate code chunk embeddings for the code chunks, code chunk label embeddings for the code chunk labels, and/or other embeddings. The code chunk embeddings may facilitate classification of the code chunks within the set of code. The code chunk label embeddings may facilitate identification of the code chunks from the set of code.

The storage component may be configured to store the code chunk embeddings and the code chunk label embeddings in an embeddings database. The embeddings database may include a vector database.

The requirement component may be configured to obtain one or more requirements of a new software application to be generated.

The pseudocode component may be configured to generate a pseudocode for the new software application to be generated. The pseudocode for the new software application may be generated based on the requirement(s) of the new software application.

In some implementations, the pseudocode for the new software application to be generated may be generated by a large language model based on the requirement(s) of the new software application and/or other information.

The identification component may be configured to identify one or more of the code chunks for use in generating the new software application. The code chunk(s) may be identified based on the pseudocode for the new software application, the code chunk label embeddings, and/or other information.

In some implementations, the identification of the code chunk(s) for use in generating the new software application may include: generation of new application code chunk label embeddings for the new software application based on the pseudocode for the new software application and/or other information; and matching of the new application code chunk label embeddings for the new software application with the code chunk label embeddings for the code chunks.

The generation component may be configured to generate the new software application. The new software application may be generated based on the identified code chunk(s) and/or other information. Code of the new software application may be synthesized using the identified code chunk(s) and/or other information.

In some implementations, the new software application may be modified based on user feedback and/or other information. In some implementations, the embeddings database may be modified based on the modification of the new software application and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for automatic software generation.

FIG. 2 illustrates an example method for automatic software generation.

FIG. 3 illustrates an example diagram for automatic software generation.

FIG. 4 illustrates examples of code chunks.

FIG. 5 illustrates an example prompt for a large language model to generate labels for code chunks.

FIG. 6A illustrates an example function to build a code chunk array from a code chunk hierarchy template and labels.

FIG. 6B illustrates an example code chunk hierarchy template and an example of a code chunk label.

FIG. 7 illustrates an example piece of code for generating code chunk label embeddings.

FIG. 8 illustrates examples of pseudocode, code chunk, prompt, and output of a large language.

FIG. 9 illustrates an example piece of code for a new software application.

### DETAILED DESCRIPTION

The present disclosure relates to automatic software generation using code chunk embeddings and code chunk label embeddings. An automatic software generation tool with improved search and retrieval capabilities for existing code generates, stores, and utilizes separate embeddings for code chunks and code chunk labels. Requirements for a new software application are used to generate a pseudocode for the new software application, and code chunks to be used in the new software application are identified using the pseudocode and the embeddings. The new software application is automatically generated using the identified code chunks.

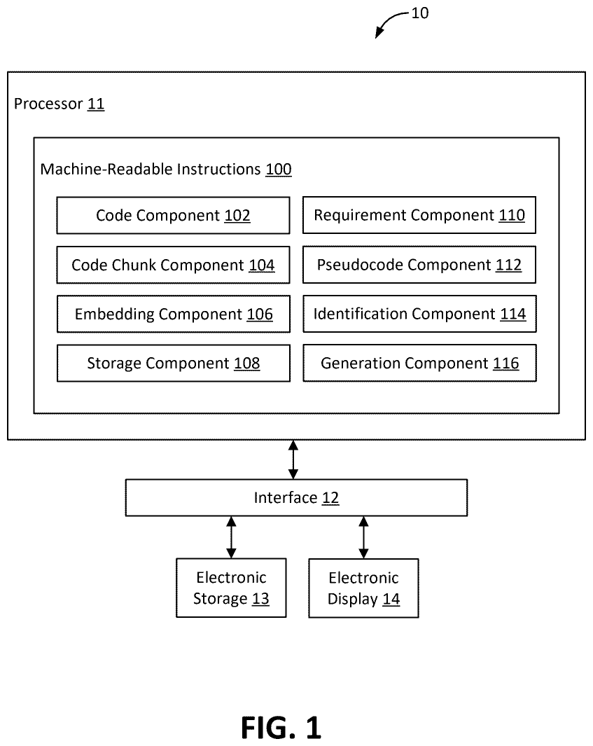

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. A set of code may be obtained by the processor 11. Code chunks within the set of code may be classified by the processor 11. Individual code chunks may be associated with code chunk labels. Code chunk embeddings for the code chunks and code chunk label embeddings for the code chunk labels may be generated by the processor 11. The code chunk embeddings may facilitate classification of the code chunks within the set of code. The code chunk label embeddings may facilitate identification of the code chunks from the set of code. The code chunk embeddings and the code chunk label embeddings may be stored by the processor 11 in an embeddings database.

One or more requirements of a new software application to be generated may be obtained by the processor 11. A pseudocode for the new software application to be generated may be generated by the processor 11 based on the requirement(s) of the new software application and/or other information. One or more of the code chunks may be identified by the processor 11 for use in generating the new software application based on the pseudocode for the new software application, the code chunk label embeddings, and/or other information. The new software application may be generated by the processor 11 based on the identified code chunk(s) and/or other information.

The electronic storage 13 may include electronic storage media that electronically stores information. The electronic storage 13 may store software algorithms, information determined by the processor 11, information received remotely, and/or other information that enables the system 10 to function properly. For example, the electronic storage 13 may store information relating to code, information relating to code chunks, information relating to code chunk labels, information relating to embeddings, information relating to code chunk embeddings, information relating to code chunk label embeddings, information relating to pseudocode, information relating to software applications, information relating to identification of code chunks, information relating to generation of software applications, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to code, information relating to code chunks, information relating to code chunk labels, information relating to embeddings, information relating to code chunk embeddings, information relating to code chunk label embeddings, information relating to pseudocode, information relating to software applications, information relating to identification of code chunks, information relating to generation of software applications, and/or other information.

A software application may refer to a set of instructions, data, programs, and/or scripts that is used to operate computing devices. A software application may be executed by a computing device to perform one or more tasks. Software development may be a complex and time-consuming process that often requires the developers to search for existing code for reuse or modify the existing code to fit the requirements of the new software application. Manual techniques for code searching, such as querying search engines, browsing through repositories, or consulting with other people, may be inefficient and prone to error. Search tools for code may not provide an effective way to synthesize new software applications using the retrieved code. Additionally, no feedback mechanism may exist for user feedback on the retrieved code. Such feedback mechanism may help developers in selecting the most relevant and efficient code for new software applications.

The present disclosure provides an automated system and method for efficiently retrieving relevant code based on a description of a new software application to be generated. The code of new software application may be synthesized using the retrieved code, making the process more efficient and less prone to errors. User feedback may be used to modify the new software application and the searching capability of the tool. The tool of the present disclosure may utilize embeddings for code retrieval and large language models for embeddings and software application generation. The tool provides an efficient and standardized way to generate new software applications by leveraging large language models and existing code, streamlining software development, streamlining software development, improving code reuse, and reduce time and effort for software development. Incorporation of user feedback further enhances the effectiveness of the tool.

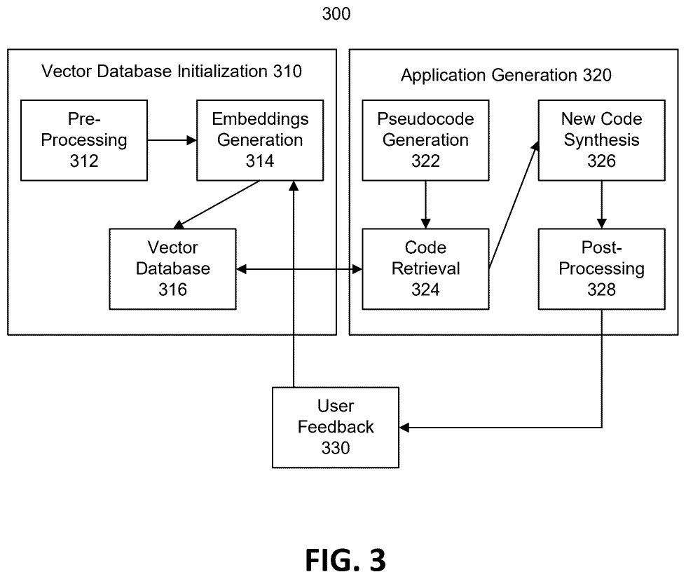

FIG. 3 illustrates an example diagram 300 for automatic software generation. The diagram 300 may include vector database initialization 310 and application generation 320. The vector database initialization 310 may include preparation of the information/values contained in a vector database 316 for existing code. The vector database initialization 310 may power the code search and generation capabilities of the tool by classifying code chunks with labels and creating embeddings for the code chunks and the labels, which are stored in the vector database 316.

The vector database initialization 310 may start with pre-processing 312 of existing code. The pre-processing 312 may include classification of existing code into code chunks. The labels for the code chunks may be generated using a code chunk hierarchy template. The labels for the code chunks may provide information on names, descriptions, functions, and/or other types of information on tasks performed by the code chunks. Rather than using a sliding window, the code chunks may be classified based on standards for how different types of code are written (code writing standard). One or more machine learning models may be trained using training data that includes code and labels for code chunks in the code. The machine learning model(s) may be trained to identify the code chunks in a piece of code and label the identified code chunks. A piece of code may be input into the machine learning model(s) and the machine learning model may output the code chunks in the piece of code, along with labels for the code chunks.

Embeddings generation 314 may be performed for the code chunks and the labels for the code chunks. Code chunk embeddings may represent the code chunks while the code chunk label embeddings may represent the labels for the code chunks. Embeddings may include numerical representations of the code chunks and the code chunk labels. For example, the embeddings generation 314 may generate vector embeddings for the code chunks and the code chunk labels, such as based on cosine similarity and/or dot product similarity.

Code chunk label embeddings may be used in vector searching via the descriptions relating to the code (e.g., information in the code chunk hierarchy template) while code chunk embeddings maybe used in vector the searching via content of the code. Code chunk embeddings may be used to generate the label for the code chunks. For example, to determine a label for a code chunk, similar code chunks may be found by looking for code chunks with similar code chunk embeddings. The labels for the similar code chunks may be used to label the code chunk. Code chunk embeddings may be used to identify similar code chunks for new software application generation. For example, a code chunk may be identified for a new software application via the code chunk label embeddings (e.g., the code chunk identified based on the code chunk label embedding matching the embedding of the requirements for the new software application). Similar code chunks may be found by looking for code chunks with similar code chunk embeddings. The code chunks identified through code chunk label embeddings and the code chunks identified through code chunks embeddings may be provided for use in generating the new software application.

The code chunk embeddings and the code chunk label embeddings may be stored in a vector database 316. The vector database 316 may store the relationships/correspondence between the code chunks, the code chunk embeddings, the code chunk labels, and the code chunk label embeddings. The vector database 316 may link the code chunks to the code chunk embeddings, the code chunk labels, and the code chunk label embeddings. For example, individual code chunk embeddings and/or individual code chunk label embeddings may be assigned an identifier. The identifier may be associated with metadata, which may include the code chunk, the code chunk labels, and/or related embeddings. For instance, individual code chunk label embeddings may be assigned an identifier, with the corresponding code chunk stored as the metadata for the identifier.

The generation and storage of the code chunk embeddings and the code chunk label embeddings enables new capabilities to search for code chunks and generate new software application using the identified code chunks. The code chunk embeddings and the code chunk label embeddings may be stored in the vector database 316 to enable retrieval of corresponding code chunks for new code synthesis.

The application generation 320 may be performed automatically based on requirements of the new software application. The application generation 320 may start with pseudocode generation 322. The pseudocode generation 322 may include generation of a pseudocode for the new software application based on requirements of the new software application. For example, the pseudocode for the new software application may be generated based on descriptions of functions to be performed, definitions, workflows, classes and objects, inputs and outputs, and/or other information relating to the new software application. The pseudocode for the new software application may be generated using one or more machine learning models. For example, the descriptions of the new software application may be input into a large language model, which may output the pseudocode for the new software application. The machine learning model(s) may output the pseudocode using the labels/language used in the labels for the code chunks.

Code retrieval 324 may be performed using the pseudocode for the new software application to retrieve relevant code chunks from/using the vector database 316. The pseudocode for the new software application may include embeddings and/or may be used to generate embeddings. The code chunk label embeddings that matches the embeddings of the pseudocode may be found in the vector database, and the corresponding code chunks may be retrieved. The code chunks similar to such code chunks may be found via code chunk embeddings and may be retrieved. The code chunk label embeddings that matches the embeddings of the pseudocode may include code chunk labels embeddings that is identical to the embeddings of the pseudocode or code chunk labels embeddings that differs from the embeddings of the pseudocode by less than a threshold amount.

The retrieved code chunks may be used for new code synthesis 326. The retrieve code chunks may be used as input for generation of the new software application. The retrieve code chunks may be used in the new software application in accordance with the requirements of the new software application and the labels/code chunk label embeddings for the retrieved code chunks. Different code chunks may be retrieved to fulfill different requirements of the new software application based on the labels/code chunk label embeddings for the retrieved code chunks. The new code generated using the retrieved code chunks may satisfy the standards and requirements of the company, the organization, and/or the person that requested the new code. For example, the governance, the standards, and/or naming conventions for the new code may be determined from the retrieved code and used to generate the new code. The new code may be generated using one or more machine learning models, such as a large language model. The machine learning model(s) may learn the context of the governance, the standards, and/or naming conventions for the new code from the retrieved code that is input into the machine learning model(s).

Post-processing 328 may be performed on the new code generated for the new software application. One or more techniques may be applied to the new code to further refine, optimize, and test the new code. Large Language Model (LLM) agents may be used as critics to review and improve the quality of the code. The LLM agents may analyze the code, identify potential issues or areas for improvement, and suggest corrections or enhancements.

The post-processing 328 may include running the newly generated code/segments of the newly generated code with test data to identify and debug any issues. This automated testing may help to ensure that the code functions as expected, adhering to the requirements of the new software application. If any bugs or errors are detected, they may be corrected in this stage.

The post-processing 328 may include other analysis processes, such as performance analysis, cyber security assessments and improvements, and code readability checks. Performance analysis may involve evaluating the efficiency of the code in terms of processing speed and resource usage. Security assessment may be carried out to ensure that the code does not have vulnerabilities that could be exploited. Code readability checks may be performed to ensure that the code follows standard formatting and style guidelines, making it easier for human developers to read and maintain.

Feedback from the post-processing 328 may be used to further train and refine the underlying machine learning models, thereby improving the quality of the code generated in future iterations. This feedback loop may contribute to the continuous improvement of the automatic software generation system.

User feedback 330 on the code of the new software application may be received. The user feedback 300 on the code of the new software application may include user ranking (e.g., approval, disapproval, rating) of the code of the new software application and/or the code chunks used in the new software application, user changes to the code of the new software application, user commenting on the code of the new software application, and/or other user feedback. The user feedback 330 may be used in the embeddings generation 314, with the results stored in the vector database 316. For example, the user may modify a code chunk in the new software application, and the embeddings generation 314 may generate embeddings for the modified code chunk and the labels for the modified code chunk for storage in the vector database 316. The ranking of the different code chunks may be stored in the vector database 316 so that when code chunks are retrieved using the vector database 316, the code chunks are retrieved with information on their ranking (e.g., for use by a user/a machine-learning model in selecting between multiple code chunks for use in generating the new software application).

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate automatic software generation. The machine-readable instructions 100 may include one or more computer program components. The machine-readable instructions 100 may include one or more of a code component 102, a code chunk component 104, an embedding component 106, a storage component 108, a requirement component 110, a pseudocode component 112, an identification component 114, a generation component 116, and/or other computer program components.

The code component 102 may be configured to obtain one or more sets of code. Obtaining a set of code may include accessing, acquiring, analyzing, determining, examining, identifying, loading, locating, opening, receiving, retrieving, reviewing, selecting, storing, and/or otherwise obtaining the set of code. The code component 102 may obtain the set(s) of code from one or more locations. For example, the code component 102 may obtain the set(s) of code from a storage location, such as the electronic storage 13, electronic storage of a device accessible via a network, and/or other locations. The code component 102 may obtain the set(s) of code from one or more hardware components (e.g., a computing device, a storage device) and/or one or more software components (e.g., software running on a computing device). In some implementations, the set(s) of code may be obtained from one or more users. For example, a user may interact with a computing device to input the set(s) of code (e.g., upload the set(s) of code, specify/identify the set(s) of code to be obtained). A set of code may be stored in one or more documents and/or one or more files. For example, a set of code may be stored in a text file, an HTML file, a script file, and/or other types of file.

A set of code may include existing code. A set of code may include multiples pieces of existing code. A piece of code may refer to a set of instructions written in a particular programming language. A piece of code may include text and/or other symbols. A piece of existing code may refer to a piece of code that has been written. A piece of existing code may refer to a piece of code written by one or more humans and/or one or more computers. Multiple pieces of existing code may be obtained as a template for automatically writing new pieces of code for a new software application.

A piece of code may include one or more code chunks. A code chunk may refer to a segment or a part of the piece of code. A code chunk may refer to a section of the piece of code responsible for one or more roles. For example, a code chunk may refer to a segment or a piece of code responsible for a specific role or function within the overall software. A code chunk may operate as building blocks of the software. A piece of code may include multiple types of code chunks. Example types of code chunks include function, definition, workflow, classes and objects, data structures, conditional statements, loops, error handling, modules and libraries, multithreading and concurrency, networking and communication, API calls and web services, database operations, event handlers, regular expressions, cryptography and security, graphics and visualization, unit tests and test cases, and/or other types of code chunks.

Individual code chunks may be associated with code chunk labels. A code chunk label may refer to a classifying words, phrases, and/or sentences attached to the code chunk. A code chunk label may provide information on the code chunk, such as what the code chunk does and/or the function performed by the code chunk in the software. A code chunk label may include identifier(s) and/or tag(s) associated with the code chunk. For example, a code chunk label may provide information on names, descriptions, functions, and/or other types of information on tasks performed by the code chunks.

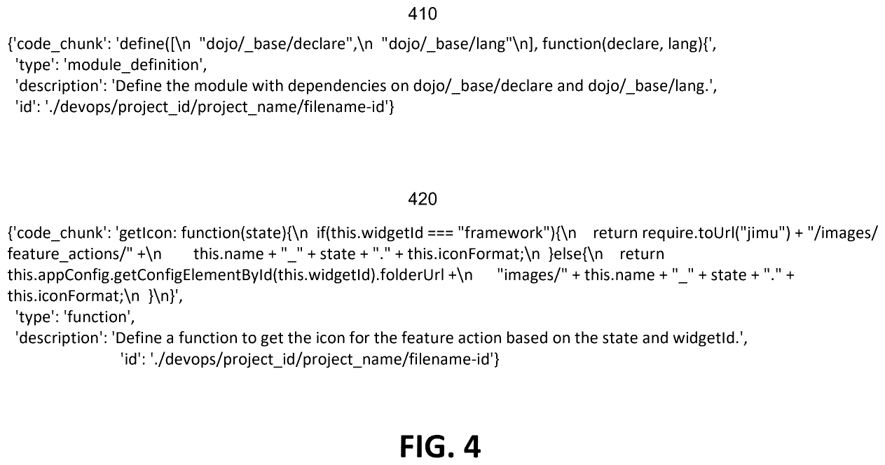

The code chunk component 104 may be configured to classify code chunks within the set(s) of code. Classifying a code chunk may include identifying the code chunk within the set(s) of code, labeling the code chunk, and/or otherwise classifying the code chunk. In some implementations, the classification of the code chunks may be performed based on one or more code writing standards and/or other information. A code writing standard may refer to a standard (e.g., governance, guidelines, formatting, best practices, styles, naming conventions) for how different types of code are written. FIG. 4 illustrates two examples of code chunks 410, 420 (a definition and a function) that have been identified from an existing piece of code.

In some implementations, code chunks within a piece of code may be classified by one or more machine learning models. For example, one or more machine learning models may be trained using training data that includes code and labels for code chunks in the code. The machine learning model(s) may be trained to identify the code chunks in a piece of code and label the identified code chunks. A piece of code may be input into the machine learning model(s) and the machine learning model may output the code chunks in the piece of code, along with labels for the code chunks.

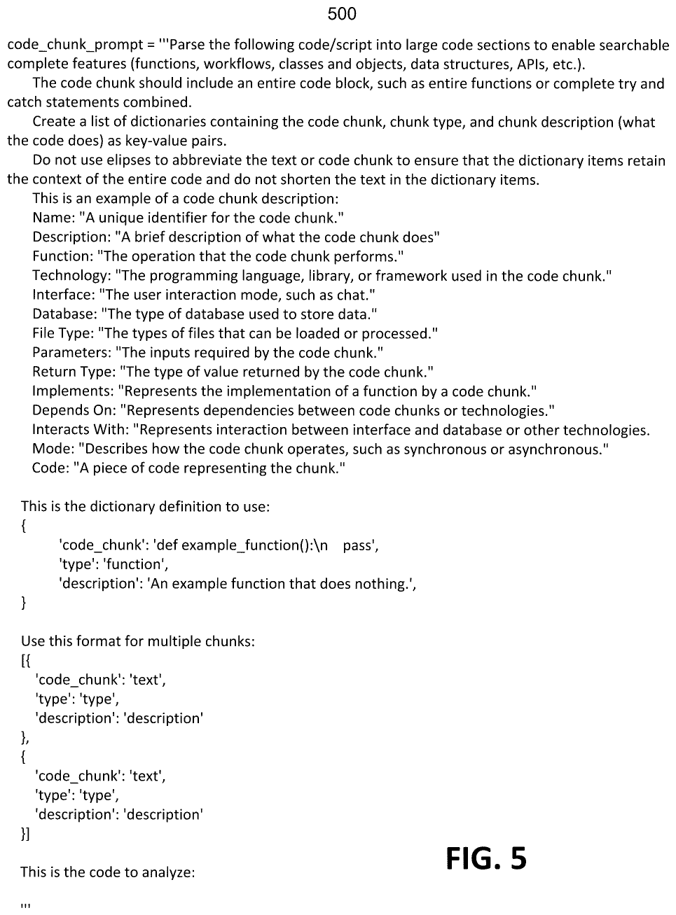

In some implementations, a code chunk label for a code chunk may be generated by a large language model based on the code chunk and/or other information. For example, a code chunk may be input into a large language model with a prompt to generate a label for the code chunk. A piece of code may be input into a large language model with a prompt to generate labels for the code chunks in the piece of code. FIG. 5 illustrates an example prompt 500 for a large language model to generate labels for code chunks. The prompt 500 may include instructions on how to generate labels for code chunks, an example of code chunk label, and information on dictionary definition and format, followed by the code to analyze for generation of labels.

In some implementations, a code chunk label for a code chunk may be generated based on code chunk embeddings for the code chunk. For example, to determine a label for a code chunk, similar code chunks may be found by looking for code chunks with similar code chunk embeddings. The labels for the similar code chunks may be used to label the code chunk. The labels for the similar code chunks may be copied into the label for the code chunk. The labels for the similar code chunks may be modified for use as the label for the code chunk.

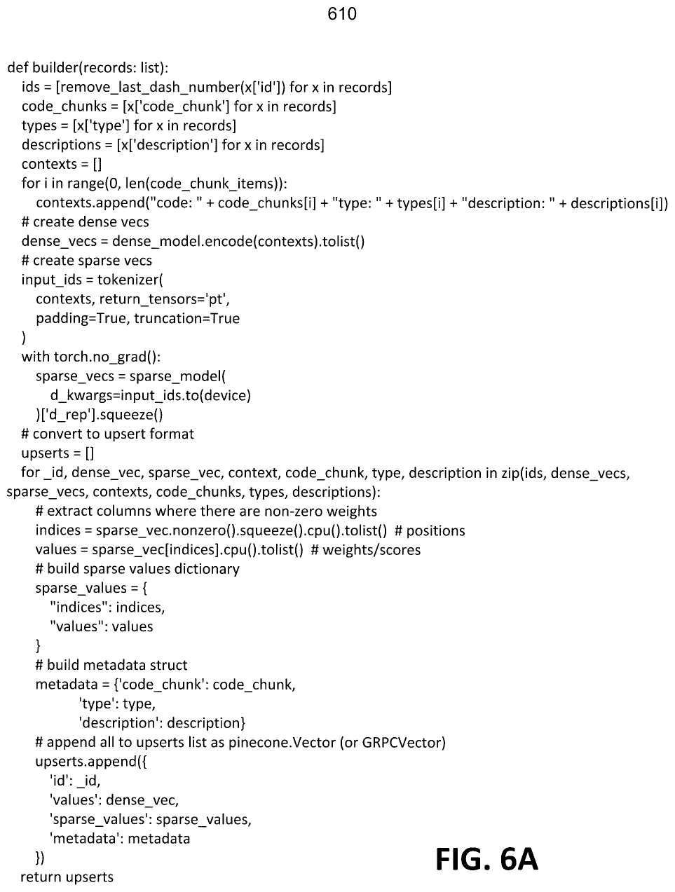

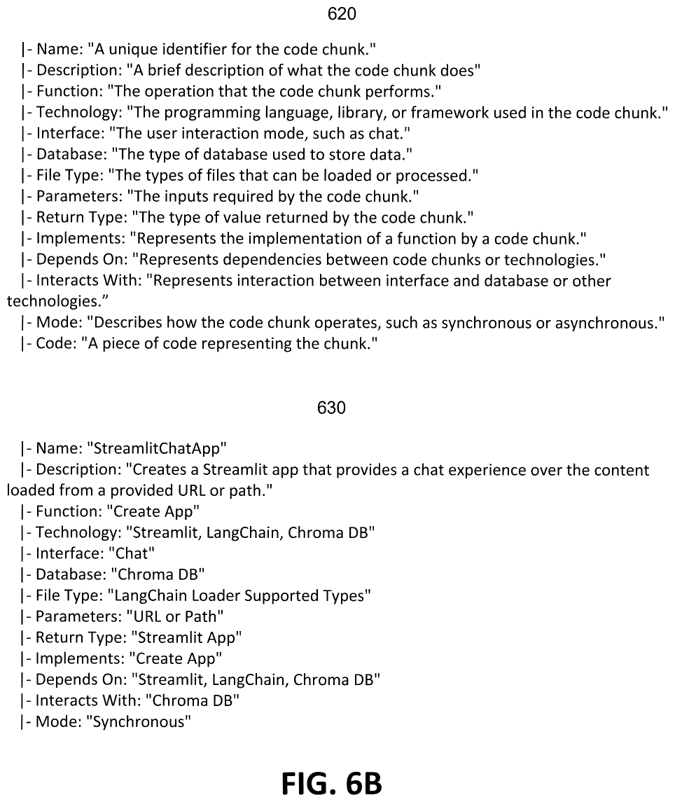

In some implementations, the classification of the code chunks within the set of code may be performed based on a code chunk hierarchy template and/or other information. A code chunk hierarchy template may refer to a model for arranging label information for a code chunk using a hierarchy of different types of label. A code chunk hierarchy template may define the types of label information to be included within a code chunk label. FIG. 6A illustrates an example function 610 to build a code chunk array from the code chunk hierarchy template and labels. A large language model may be instructed to fill out the code chunk hierarchy template for the input code chunk.

In some implementations, the code chunk hierarchy template may include a name field, a description field, a function field, a technology field, an interface field, a database field, a file type field, a parameters field, a return type field, an implements field, a depends on field, an interacts with field, a mode field, a code field, and/or other fields. The name field may refer to a field for inserting/storing a unique-identifier for a code chunk. The description field may refer to a field for inserting/storing a description of what the code chunk does. The function field may refer to a field for inserting/storing the operation that the code chunk performs. The technology field may refer to a field for inserting/storing the programming language, library, and/or framework used in the code chunk. The interface field may refer to a field for inserting/storing the user interaction mode (e.g., chat). The database field may refer to a field for inserting/storing the type of database used to store data for the code chunk. The file type field may refer to a field for inserting/storing the types of files that can be loaded or processed. The parameters field may refer to a field for inserting/storing the inputs required by the code chunk. The return type field may refer to a field for inserting/storing the type of value returned by the code chunk. The implements field may refer to a field for inserting/storing information that represents the implementation of a function by the code chunk. The depends on field may refer to a field for inserting/storing information that represents dependencies between code chunks or technologies. The interacts with field may refer to a field for inserting/storing information that represents interaction between interface and database or other technologies for the code chunk. The mode field may refer to a field for inserting/storing descriptions of how the code chunk operates (e.g., synchronous, asynchronous). The code field may refer to a field for inserting/storing information on a piece of code representing the chunk (e.g., the piece of code, the location of the piece of code).

FIG. 6B illustrates an example code chunk hierarchy template 620 and an example of a code chunk label 630 generated based on the code chunk hierarchy template 620. Other types of code chunk hierarchy template and other types of code chunk label are contemplated.

The embedding component 106 may be configured to generate embeddings. Generating an embedding may include calculating, constructing, creating, determining, making, producing, and/or otherwise generating the embedding. Embeddings may be generated based on cosine similarity, dot product similarity, and/or other measures of similarity.

An embedding may refer to one or more values that represents something else. An embedding may refer to a numerical representation of something else (e.g., a code chunk, a code chunk label). An embedding may include a vector embedding. A vector embedding may include conversion of one or more words, one or more phrases, one or more sentences, and/or one or more symbols into a numerical representation (e.g., a vector). Use of embeddings may make the process of searching for relevant code more efficient.

The embedding component 106 may be configured to generate code chunk embeddings for the code chunks, code chunk label embeddings for the code chunk labels, and/or other embeddings. Separate embeddings may be generated for code chunks and the corresponding code chunk labels. A code chunk embedding may represent a code chunk. A code chunk embedding may include a numerical representation of a code chunk. The embedding component 106 may encode the code chunk into a code chunk embedding that captures the meaning and context of the code chunk. A code chunk embedding may represent a code chunk in a numerical form that captures the meaning and context of the code chunk. This facilitates the classification of the code chunks within a set of code. A code chunk label embedding may represent the label for a code chunk (the code chunk label). A code chunk label embedding may include a numerical representation of a code chunk label. The embedding component 106 may encode the code chunk label into a code chunk label embedding that captures the meaning and context of the code chunk label. A code chunk label embedding represent the label of the corresponding code chunk, facilitating in the identification of the code chunks from a set of code.

One or more code chunk label embeddings may be generated for a code chunk. For example, a single code chunk label embedding may be generated as numerical representation of the entirety of the code chunk label (e.g., information filled out using the code chunk hierarchy template, minus the code). As another example, multiple code chunk label embeddings may be generated as numerical representations of different parts of the code chunk label.

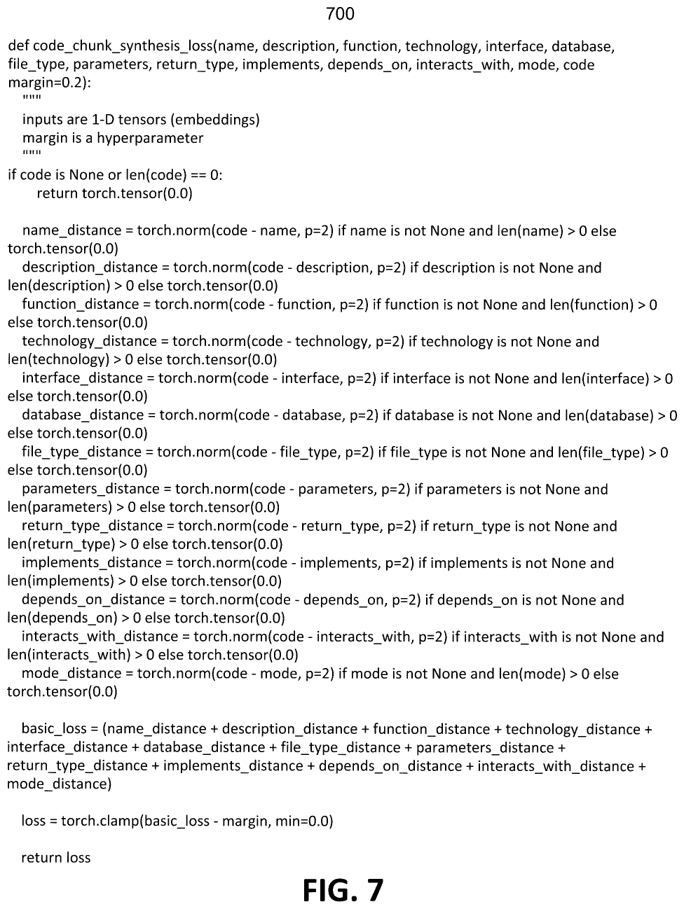

In some implementations, the code chunk label embeddings may be generated using a custom loss function that accounts for individual code chunk hierarchy template information. An example piece of code 700 for generating the code chunk label embeddings is illustrated in FIG. 7. The example code 700 may be designed to work in line with the code chunk hierarchy template. The code 700 may break down a code script into chunks and label each chunk according to the code chunk hierarchy template.

In the code 700, ‘code_margin=0.2’ may be a parameter that sets a margin or tolerance value for the code chunking process. This parameter may function as a threshold used to decide when a piece of code is similar enough to a known code chunk to be considered the same code chunk. A lower margin may require two code to be very similar to be considered the same code chunk, and a higher margin may allow for more variation in code language for the two code to be considered the same code chunk. The ‘p=2’ parameter may be used in the calculation of distances between vectors in the embeddings space when identifying similar code chunks. For example, ‘p=2’ may refer to the use of Euclidean distance to measure the distance between vectors. The ‘len(name)>0’ parameter may be a condition that checks if the ‘name’ field in the code chunk hierarchy template is filled out. If the length of the ‘name’ is greater than 0, it indicates that a unique identifier for the code chunk has been provided. This condition may ensure that only code chunks with a provided unique identifier are processed further. The user may tune the parameters of the code 700.

The code chunk embeddings may facilitate classification of the code chunks within the set(s) of code. The code chunk embeddings may be used to identify similar code chunks, and the existing labels within the similar code chunks may be used to label the code chunks without labels. The code chunk label embeddings may facilitate identification of the code chunks from the set(s) of code. The code chunk label embeddings may be used to identify code chunks that will be used to generate the code for the new software application.

The storage component 108 may be configured to store the code chunk embeddings and the code chunk label embeddings in one or more embeddings databases. The embeddings database(s) may be located in in one or more non-transient storage media and/or other storage media, such as the electronic storage 13, electronic storage of a device accessible via a network, and/or other locations. An embeddings database may include a vector database. An embeddings database may be a storage system where the code chunk embeddings and code chunk label embeddings are stored. Storage of the code chunk embeddings and code chunk label embeddings in the embeddings database(s) allows for efficient retrieval of corresponding code chunks for new code synthesis or generation. The code chunk embeddings and the code chunk label embeddings may be stored in the embeddings database(s) to enable retrieval of code chunks for new code synthesis/generation. The embeddings database(s) may be queried based on requirements of the new software application to be generated to retrieve the relevant code chunks.

The code chunks, the code chunk embeddings, information on the code chunks, information on the code chunk embeddings, the code chunk labels, the code chunk label embeddings, information on the code chunk labels, information on the code chunk label embeddings, and/or other information may be stored in the embeddings database(s). For example, relationships/correspondence between the code chunks, the code chunk embeddings, the code chunk labels, and the code chunk label embeddings may be stored in the embeddings database(s). The embeddings database(s) may link the code chunks to the code chunk embeddings, the code chunk labels, and the code chunk label embeddings. For example, individual code chunk embeddings and/or individual code chunk label embeddings may be assigned an identifier. The identifier may be associated with metadata, which may include the code chunk, the code chunk labels, and/or related embeddings. For instance, individual code chunk label embeddings may be assigned an identifier, with the corresponding code chunk stored as the metadata for the identifier.

The requirement component 110 may be configured to obtain one or more requirements of a new software application to be generated. Obtaining a requirement may include accessing, acquiring, analyzing, determining, examining, identifying, loading, locating, opening, receiving, retrieving, reviewing, selecting, storing, and/or otherwise obtaining the requirement. The requirement component 110 may obtain the requirement(s) from one or more locations. For example, the requirement component 110 may obtain the requirement(s) from a storage location, such as the electronic storage 13, electronic storage of a device accessible via a network, and/or other locations. The requirement component 110 may obtain the requirement(s) from one or more hardware components (e.g., a computing device, a storage device) and/or one or more software components (e.g., software running on a computing device). In some implementations, the requirement(s) may be obtained from one or more users. For example, a user may interact with a computing device to input the requirement(s) (e.g., upload the requirement(s), specify/identify the requirement(s) to be obtained). The requirement(s) may be stored in one or more documents and/or one or more files. The requirement(s) may be obtained based on user interaction with one or more interface devices (e.g., typing in the requirement(s) using a keyboard).

A requirement of a new software application to be generated may refer to a functional need that the new software application is to satisfy. A requirement of a new software application may include information relating to inputs, outputs, functions, definitions, workflows, classes, objects, and/or other information on operation of the new software application. A requirement of a new software application may include description/explanation of what information is to be received by the new software application, how the information is to be processed by the new software application, and/or what information is to be output by the new software application. A requirement of a new software application may include code chunk hierarchy template information for the new software application. A requirement of a new software application may include description/explanation of the types of information set forth in the code chunk hierarchy template (e.g., description, function, technology, interface, database, file type, parameters, return type, implements, depends on, interacts with, mode).

The pseudocode component 112 may be configured to generate a pseudocode for the new software application to be generated. Generating a pseudocode may include calculating, constructing, creating, determining, making, producing, and/or otherwise generating the pseudocode. A pseudocode may refer to a simplified version of a software's code that does not include all the details and complexities of the actual code but is easier to understand.

The pseudocode for the new software application may be generated based on the requirement(s) of the new software application. For example, the pseudocode for the new software application may be generated based on descriptions of functions to be performed, definitions, workflows, classes and objects, inputs and outputs, and/or other information relating to the new software application. The pseudocode component 112 may convert the requirement(s) into a description of steps to be performed by the new software application. The pseudocode may be used to identify the code chunks to be used in the new software application.

The pseudocode for the new software application may be generated using one or more machine learning models. For example, the requirement(s) of the new software application may be input into a large language model with an instruction to generate a pseudocode for the new software application using the requirement(s). The large language model may be instructed to generate the pseudocode using the labels/language used in the labels for the code chunks (e.g., the types of information set forth in the code chunk hierarchy template). The large language model may output the pseudocode using the labels/language used in the labels for the code chunks. A prompt for the large language model may outline the requirements for the new software application. The prompt may include details about the desired functionality and characteristics of the new software application. To guide the large language model is generating the pseudocode using the labels, the prompt may include explicit requirement about use of the labels. For example, the prompt may include an instruction that the pseudocode “should use language of the code chunk labels.” The large language model may use the detailed instructions in the prompt to generate pseudocode that employs the language of the code chunk labels.

The identification component 114 may be configured to identify one or more of the code chunks for use in generating the new software application. Identifying a code chunk may include ascertaining, choosing, discovering, finding, selecting, and/or otherwise identifying the code chunk. The code chunk(s) may be identified using the information stored in the embeddings database(s). The embeddings database(s) may be searched to identify the code chunks for use in generating the new software application.

The code chunk(s) may be identified based on the pseudocode for the new software application, the code chunk label embeddings, and/or other information. The code chucks with code chunk label embeddings that matches the pseudocode for the new software application may be identified. For example, the pseudocode may indicate descriptions of functions to be performed, definitions, workflows, classes and objects, and inputs and outputs of the new software application, and the code chunks to build out the functions, definitions, workflows, classes and objects, and inputs and outputs may be identified based on the code chunk label embeddings. The identification component 114 may use the code chunk label embeddings to figure out whether the corresponding code can be used to fulfill one or more parts of the pseudocode. For instance, the pseudocode may indicate the functions, definitions, workflows, classes and objects, and inputs and outputs of the new software application, and the embeddings database(s) may be queried to retrieve the code chunks that are needed to build out the functions, definitions, workflows, classes and objects, and inputs and outputs of the new software application.

In some implementations, the identification of the code chunk(s) for use in generating the new software application may include: generation of new application code chunk label embeddings for the new software application based on the pseudocode for the new software application and/or other information; and matching of the new application code chunk label embeddings for the new software application with the code chunk label embeddings for the code chunks. In some implementations, the pseudocode for the new software application may include code chunk label embeddings for the new software application.

For example, based on the requirement(s) of the new software application and/or the pseudocode for the new software application, a code chunk hierarchy template may be filled out for individual code chunks that are needed. In some implementations, the code chunk hierarchy templates may be filled out using one or more machine learning models (e.g., large language model). For example, the requirement(s) of the new software application and/or the pseudocode for the new software application may be input into the machine learning model(s) trained to output code chunk labels for the code chunks. The machine learning model(s) may be trained using training data that includes (1) requirements and/or pseudocode, and (2) code chunk labels for code chunks. The machine learning model(s) may be trained to determine needed code chunks and generate the corresponding code chunk labels. The requirement(s) of the new software application and/or the pseudocode for the new software application may be input into a large language model with an instruction to output the code chunk labels. For example, the prompt may include an instruction to fill out the hierarchy information, followed by the type of information in the code chunk hierarchy template (e.g., name, description, function, etc.).

Thus, the code chunk labels may be generated for the code chunks to be included/used in the new software application. The embeddings for these code chunk labels (new application code chunk label embeddings) may be generated and used to search for matching code chunk label embeddings in the embeddings database(s). A code chunk label embeddings that matches a new application code chunk label embedding may include embeddings identical to the new application code chunk label embedding or embeddings that differ from the new application code chunk label embedding by less than a threshold amount. The codes of the identified code chunk labels (e.g., stored as metadata of the code chunk labels, found using the linkage between the code chunk labels and the code chunks in the embeddings database(s)) may be obtained for use in generating the new software application.

In some implementations, code chunks similar to the identified code chunks may be obtained for use in generating the new software application. For example, after code chunks have been identified for use via code chunk label embeddings, the code chunk embeddings of the identified code chunks may be used to identify similar code chunks (e.g., code chunks with embeddings that differ from the embeddings of the identified code chunks by less than a threshold amount). The similar code chunks may be obtained for use in generating the new software application.

The generation component 116 may be configured to generate the new software application. Generating a software application may include calculating, constructing, creating, determining, making, producing, and/or otherwise generating the software application. Generating a software application may include synthesizing the code of the new software application. The new software application may be generated based on the identified code chunk(s) and/or other information. The code of the new software application may be synthesized using the identified code chunk(s) and/or other information.

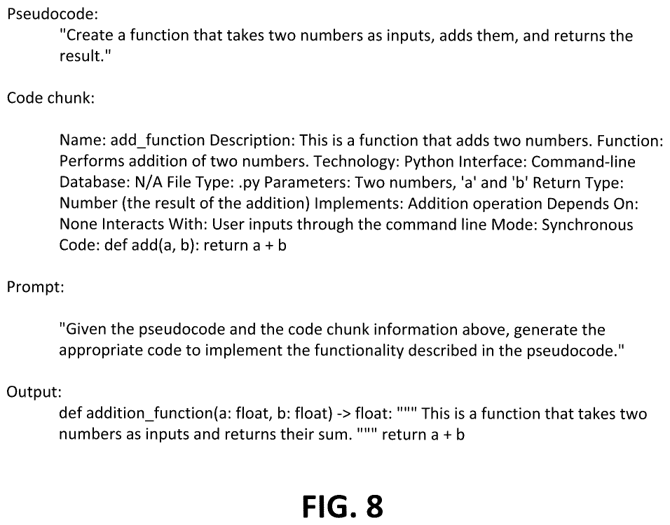

The identified code chunks may be assembled to generate the new software application using one or more machine learning models (e.g., large language model). For example, the identified code chunks, the pseudocode for the new software application, and/or other information relating to the new software application may be input into the machine learning model(s) trained to output the code of the new software application. The machine learning model(s) may be trained using training data that includes (1) code chunks and pseudocode, and (2) code for new software application. The machine learning model(s) may be trained to arrange and modify the input code chunks based on the pseudocode to generate the code for the new software application. The identified code chunks, the pseudocode for the new software application, and/or other information relating to the new software application may be input into a large language model with an instruction to generate the new software application using the identified code chunks. FIG. 8 illustrates examples of pseudocode, code chunk, prompt, and output of a large language. In this examples shown in FIG. 8, the large language model may have used the provided pseudocode and code chunk information to generate new code that implements the desired functionality. The resulting code (output) may be a Python function that takes two numbers as inputs, adds them, and returns the result, adhering to the requirements outlined in the pseudocode.

The code of the new software application may automatically satisfy the standards used in the existing set(s) of code/the identified code chunks. For example, a machine learning model/large language model may infer/learn the governance, guidelines, formatting, best practices, styles, and/or naming conventions for code writing from the code chunks input into the model for use in generating the new software application. The code of the new software application generated from the code chunks may follow/comply with the standards of the code chunks provided as input.

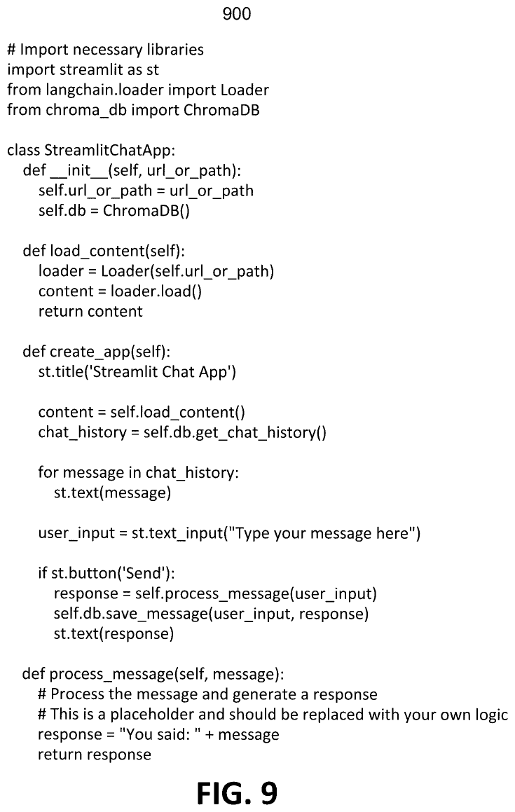

FIG. 9 illustrates an example piece of code 900 for a new software application. The code 900 may include a Python script that builds a simple chat application using the Streamlit library. Streamlit may be an open-source Python library for creating custom web applications. The script may start by importing the necessary libraries, namely Streamlit, a custom ‘Loader’ class, and ‘ChromaDB’, a hypothetical database class. A class named ‘StreamlitChatApp’ may be defined, which contains methods for initializing the app, loading content, creating the app interface, and processing user messages. The ‘init’ method may initialize the app by setting the ‘url_or_path’ for the content loader and instantiating the ‘ChromaDB’ database. The ‘load_content’ method may use a ‘Loader’ instance to load content from the specified ‘url_or_path’.

The ‘create_app’ method may define the layout and functionality of the chat app. It may set the title of the app, load the content, retrieve chat history from the database, and display previous messages. It may also provide a text input field for the user to type their message and a button to send the message. When the ‘Send’ button is pressed, the ‘process_message’ method may be called to generate a response. Both the user's message and the response may then be saved in the database, and the response may be displayed in the chat.

The ‘process_message’ method may be designed to process the user's message and generate a response. In the code 900, it may echo the user's message. However, in a fully developed chat app, this method may involve more complex logic, potentially including natural language processing and machine learning algorithms. Generation of other types of code is contemplated.

In some implementations, the new software application may be modified based on user feedback and/or other information. The user feedback may include ranking of the code chunks used in the new software application, user modification of the code of the new software application, user commenting on the code chunks used in the new software application, user commenting on the code of the new software application, and/or user feedback.

In some implementations, the embeddings database(s) may be modified based on the modification of the new software application and/or other information. For example, the user may modify one or more parts of the code of the new software application. The modified code chunk(s) in the new software application may be identified, and embeddings may be generated for the modified code chunk(s) and the corresponding modified code chunk label(s). The embeddings may be stored in the embeddings database(s), which enables the user modified code chunk(s) to be identified for use in generating new software application. User rankings and/or comments may be stored in the embeddings database(s). When code chunks are retrieved using the embeddings database(s), the user rankings and/or comments for the code chunks may be provided to the user and/or models for generating new software application.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) computer-readable storage medium may include read-only memory, random access memory, magnetic disk storage media, optical storage media, flash memory devices, and others, and a machine-readable transmission medium may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

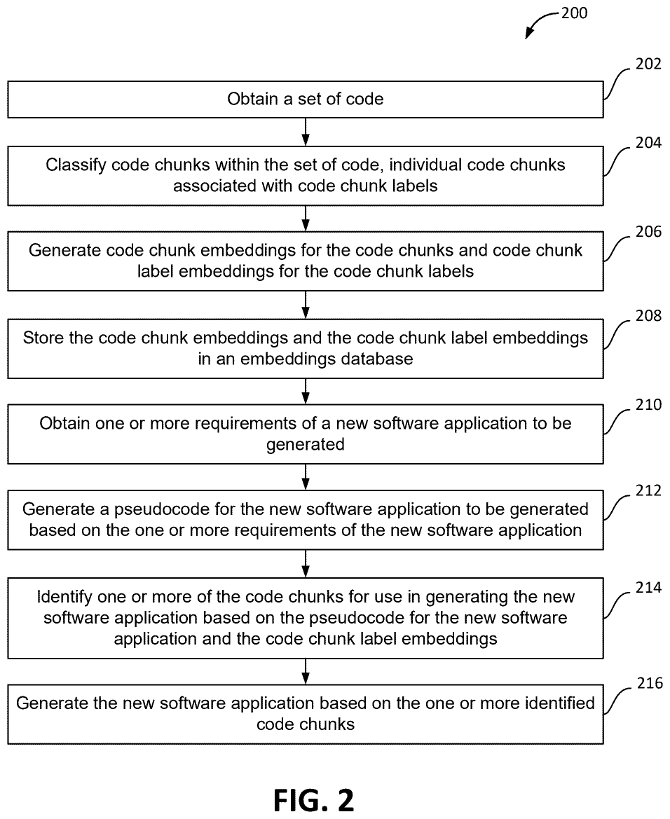

FIG. 2 illustrates method 200 for automatic software generation. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, a set of code may be obtained. In some implementations, operation 202 may be performed by a processor component the same as or similar to the code component 102 (Shown in FIG. 1 and described herein).

At operation 204, code chunks within the set of code may be classified. Individual code chunks may be associated with code chunk labels. In some implementations, operation 204 may be performed by a processor component the same as or similar to the code chunk component 104 (Shown in FIG. 1 and described herein).

At operation 206, code chunk embeddings for the code chunks and code chunk label embeddings for the code chunk labels may be generated. The code chunk embeddings may facilitate classification of the code chunks within the set of code. The code chunk label embeddings may facilitate identification of the code chunks from the set of code. In some implementations, operation 206 may be performed by a processor component the same as or similar to the embedding component 106 (Shown in FIG. 1 and described herein).

At operation 208, the code chunk embeddings and the code chunk label embeddings may be stored in an embeddings database. In some implementations, operation 208 may be performed by a processor component the same as or similar to the storage component 108 (Shown in FIG. 1 and described herein).

At operation 210, one or more requirements of a new software application to be generated may be obtained. In some implementations, operation 210 may be performed by a processor component the same as or similar to the requirement component 110 (Shown in FIG. 1 and described herein).

At operation 212, a pseudocode for the new software application to be generated may be generated based on the requirement(s) of the new software application and/or other information. In some implementations, operation 212 may be performed by a processor component the same as or similar to the pseudocode component 112 (Shown in FIG. 1 and described herein).

At operation 214, one or more of the code chunks may be identified for use in generating the new software application based on the pseudocode for the new software application, the code chunk label embeddings, and/or other information. In some implementations, operation 214 may be performed by a processor component the same as or similar to the identification component 114 (Shown in FIG. 1 and described herein).

At operation 216, the new software application may be generated based on the identified code chunk(s) and/or other information. In some implementations, operation 216 may be performed by a processor component the same as or similar to the generation component 116 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for automatic software generation, the system comprising:
one or more physical processors configured by machine-readable instructions to:
obtain a set of code;
classify code chunks within the set of code, individual code chunks associated with code chunk labels;
generate code chunk embeddings for the code chunks and code chunk label embeddings for the code chunk labels, wherein the code chunk embeddings facilitate classification of the code chunks within the set of code and the code chunk label embeddings facilitate identification of the code chunks from the set of code;
store the code chunk embeddings and the code chunk label embeddings in an embeddings database;
obtain one or more requirements of a new software application to be generated;
generate a pseudocode for the new software application to be generated based on the one or more requirements of the new software application;
identify one or more of the code chunks for use in generating the new software application based on the pseudocode for the new software application and the code chunk label embeddings; and
generate the new software application based on the one or more identified code chunks.

2. The system of claim 1, wherein the classification of the code chunks is performed based on one or more code writing standards.

3. The system of claim 1, wherein the classification of a given code chunk includes identification and labeling of the given code chunk.

4. The system of claim 3, wherein the labeling of the given code chunk is performed based on a code chunk hierarchy template.

5. The system of claim 4, wherein the code chunk hierarchy template includes a name field, a description field, a function field, a technology field, an interface field, a database field, a file type field, a parameters field, a return type field, an implements field, a depends on field, an interacts with field, a mode field, and a code field.

6. The system of claim 1, wherein a given code chunk label for a given code chunk is generated by a large language model based on the given code chunk.

7. The system of claim 1, wherein the pseudocode for the new software application to be generated is generated by a large language model based on the one or more requirements of the new software application.

8. The system of claim 1, wherein the identification of the one or more of the code chunks for use in generating the new software application includes:
generation of new application code chunk label embeddings for the new software application based on the pseudocode for the new software application; and
matching of the new application code chunk label embeddings for the new software application with the code chunk label embeddings for the code chunks.

9. The system of claim 1, wherein the new software application is modified based on user feedback.

10. The system of claim 9, wherein the embeddings database is modified based on the modification of the new software application.

11. A method for automatic software generation, the method comprising:
obtaining a set of code;
classifying code chunks within the set of code, individual code chunks associated with code chunk labels;
generating code chunk embeddings for the code chunks and code chunk label embeddings for the code chunk labels, wherein the code chunk embeddings facilitate classification of the code chunks within the set of code and the code chunk label embeddings facilitate identification of the code chunks from the set of code;
storing the code chunk embeddings and the code chunk label embeddings in an embeddings database;
obtaining one or more requirements of a new software application to be generated;
generating a pseudocode for the new software application to be generated based on the one or more requirements of the new software application;
identifying one or more of the code chunks for use in generating the new software application based on the pseudocode for the new software application and the code chunk label embeddings; and
generating the new software application based on the one or more identified code chunks.

12. The method of claim 11, wherein classifying the code chunks is performed based on one or more code writing standards.

13. The method of claim 11, wherein classifying a given code chunk includes identifying and/or labeling the given code chunk.

14. The method of claim 13, wherein labeling the given code chunk is performed based on a code chunk hierarchy template.

15. The method of claim 14, wherein the code chunk hierarchy template includes a name field, a description field, a function field, a technology field, an interface field, a database field, a file type field, a parameters field, a return type field, an implements field, a depends on field, an interacts with field, a mode field, and a code field.

16. The method of claim 11, wherein a given code chunk label for a given code chunk is generated by a large language model based on the given code chunk.

17. The method of claim 11, wherein the pseudocode for the new software application to be generated is generated by a large language model based on the one or more requirements of the new software application.

18. The method of claim 11, wherein identifying the one or more of the code chunks for use in generating the new software application includes:
generating new application code chunk label embeddings for the new software application based on the pseudocode for the new software application; and
matching the new application code chunk label embeddings for the new software application with the code chunk label embeddings for the code chunks.

19. The method of claim 11, wherein the new software application is modified based on user feedback.

20. The method of claim 19, wherein the embeddings database is modified based on the modification of the new software application.
